(19) United States
(12) Patent Application Publication
(10) Pub. No.: US 2010/0097176 A1
(43) Pub. Date: Apr. 22, 2010

(54) INPUT DEVICE AND USER AUTHENTICATION METHOD

(75) Inventors: Satoshi SAKURAI, Shinagawa (JP); Nobuo YATSUO, Shinagawa (JP); Keita HARADA, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, TOKYO (JP)

(21) Appl. No.: 12/647,165

(22) Filed: Dec. 24, 2009

Related U.S. Application Data
(63) Continuation of application No. 11/033,127, filed on Jan. 12, 2005.

(30) Foreign Application Priority Data
Jan. 14, 2004 (JP) 2004-006193

(51) Int. Cl. G06F 7/04; G06F 3/041

(52) U.S. Cl. 340/5.8; 345/173

(57) ABSTRACT

An input device having a given input screen includes a first unit that generates data indicating any one of a touch position, a touch area, and a touching time, the touch position being a position touched by an object, the touch area being an area touched by the object, and the touching time being a period touched by the object, a second unit that generates password codes based on any one of the touch position, the touch area, and the touching time, and a third unit that judges whether a user is an authorized user based on the password code. It is possible to generate password codes including data of any one of the touch position, the touch area, and the touching time. Accordingly, the password cannot be stolen by others, and the input device with which impersonation or spoofing is difficult and the password need not be input.

### CROSS-REFERENCE TO RELATED APPLICATIONS

This application is a Continuation of and claims the benefit of U.S. Ser. No. 11/033,127, filed Jan. 12, 2005, in the United States Patent and Trademark Office and Japanese Application No. 2004-006193 filed Jan. 14, 2004, the disclosure of which are Incorporated herein by reference.

### BACKGROUND OF THE INVENTION

1. Field of the Invention

This invention generally relates to an input device and user authentication method.

2. Description of the Related Art

Conventionally, when logging into a personal computer or the like, a user authentication was performed by inputting a password on a keyboard or the like. However, there is the possibility that the password may be learned if anyone steals a look while typing the password on the keyboard. Another authentication method has been proposed by installing a fingerprint authentication device. However, there is a disadvantage in terms of price because the authentication device needs to be added separately. Conventional techniques to solve the above-mentioned problems have been proposed as follows.

Japanese Patent Application Publication No. 11-272423 (hereinafter referred to as Document 1) discloses an input device that calculates a touch area of an object to an input screen. If the touch area exceeds a given threshold, a soft keyboard for inputting the password is displayed on a display device.

Japanese Patent Application Publication No. 07-295673 (hereinafter referred to as Document 2) discloses a device that displays a graphical image on the screen so that the user may touch the image on the screen. If the user touches a given area on the image and a position and a sequence touched by the user are same as predetermined ones, then an access is allowed.

Japanese Patent Application Publication No. 10-31527 (hereinafter referred to as Document 3) discloses a device that calculates an input password. This password is calculated by a combination of a contact time and a non-contact time. The contact time is a period while a finger or the like is in touch with a touch panel. The input password is verified by a registered password.

The input device disclosed in Document 1 verifies the user whether the user is a valid user, by calculating the touch area of the object to the input screen. However, if a pen is prepared for input on the screen, the touch area is always the same. Therefore, there is a problem in that the valid user cannot be judged correctly. In addition, the user needs to input the password separately.

The device disclosed in Document 2 verifies the user with the position and the sequence touched by the user. However, once anyone else learns the position and the sequence, an unauthorized user is able to use the device.

The device disclosed in Document 3 verifies with the combination of the contact time and non-contact time. However, if an unauthorized user watches the valid user operating and inputs the contact time and the non-contact time in the same manner, there is another problem in that the unauthorized user is able to use the device.

### SUMMARY OF THE INVENTION

It is therefore an object of the present invention to provide an input device and user authentication method, with which impersonation or spoofing is difficult and the password need not be input.

According to an aspect of the present invention, preferably, there is provided an input device having a given input screen includes a first unit that generates data indicating any one of a touch position, a touch area, and a touching time, the touch position being a position touched by an object, the touch area being an area touched by the object, and the touching time being a period touched by the object, a second unit that generates password codes based on any one of the touch position, the touch area, and the touching time, and a third unit that judges whether a user is an authorized user based on the password code. It is possible to generate password codes including data of any one of the touch position, the touch area, and the touching time. Accordingly, the password cannot be stolen by others, and the input device with which impersonation or spoofing is difficult and the password need not be input.

On the above-mentioned input device having the given input screen, the first unit may generate two types of data indicating the touch position and touch area, and the second unit generates the password codes based on the touch position and the touch area. It is possible to generate password codes including two types of data, the touch position and the touch area. The reliability of the password code can be enhanced.

On the above-mentioned input device having the given input screen, the first unit may generate three types of data indicating the touch position, the touch area, and the touching time, and the second unit generates the password codes based on the touch position, touch area, and the touching time. It is possible to generate password codes including three types of data, the touch position, the touch area, and the touching time. The reliability of the password code can be enhanced.

On the above-mentioned input device having the given input screen may further include a fourth unit that generates data indicating an untouched time, the untouched time being a period from a time when a touched object is removed from the input screen to another time when a removed object starts touching the input screen again, and the second unit generates the password codes based on the touch position, the touch area, the touching time, and the untouched time. It is possible to generate password codes by adding another type of data, the untouched time. The reliability of the password code can be enhanced.

On the above-mentioned input device having the given input screen, the first unit may generate two types of data indicating the touch area and the touching time, and the second unit generates the password codes based on the touch area and the touching time. It is possible to generate password codes including two types of data, the touch area and the touching time. The reliability of the password code can be enhanced.

On the above-mentioned input device having the given input screen may further include a fourth unit that generates data indicating an untouched time, the untouched time being a period from a time when a touched object is removed from the input screen to another time when a removed object starts touching the input screen again, and the second unit generates the password codes based on touch area, the touching time, and the untouched time. It is possible to generate password codes by adding another type of data, the untouched time. The reliability of the password code can be enhanced.

According to another aspect of the present invention, preferably, there is provided an input device having a given input screen includes an untouched time measurement unit that measures a period from a time when a touched object is removed from the input screen to another time when a removed object starts touching the input screen again, a password code generation unit that generates password codes based on the untouched time, and a judgment unit that judges whether a user is an authorized user. It is possible to generate password codes by adding another type of data, the untouched time. The reliability of the password code can be enhanced.

On the above-mentioned input device having the given input screen, a password code generation unit that generates password codes for every given sampling cycle, and a judgment unit that judges whether a user is an authorized user according to the number of the password codes. The number of password codes is compared with the number of the prepared password codes. If the numbers are greatly different, the user is determined an unauthorized user. It is thus possible to shorten a determination process.

According to yet another aspect of the present invention, preferably, there is provided a user authentication method including the steps of generating data indicating any one of a touch position, a touch area, and a touching time, the touch position being a position touched by an object, the touch area being an area touched by the object, and the touching time being a period touched by the object, generating password codes is based on any one of the touch position, the touch area, and the touching time, and judging whether a user is an authorized user is based on the password codes. It is possible to generate password codes including data of any one of the touch position, the touch area, and the touching time. Accordingly, the password cannot be stolen by others, and the input device with which impersonation or spoofing is difficult and the password need not be input.

On the above-mentioned user authentication method, the step of generating data may generate two types of data indicating the touch position and the touch area, and the step of generating password codes generates the password codes based on the touch position and the touch area are generated. It is possible to generate password codes including two types of data, the touch position and the touch area. The reliability of the password code can be enhanced.

On the above-mentioned user authentication method, the step of generating data may generate three types of data indicating the touch position, touch area, and the touching time are generated, and the step of generating the password codes generates the password codes based on the touch position, the touch area, and the touching time are generated. It is possible to generate password codes including three types of data, the touch position, the touch area, and the touching time. The reliability of the password code can be enhanced.

On the above-mentioned user authentication method, the user authentication method may further include a step of generating data indicating an untouched time, the untouched time being a period from a time when a touched object is removed from the input screen to another time when a removed object starts touching the input screen again, and the step of generating the password codes generates the password codes based on the touch position, the touch area, the touching time, and the untouched time. It is possible to generate password codes by adding another type of data, the untouched time. The reliability of the password code can be enhanced.

On the above-mentioned user authentication method, the step of generating data may generate two types of data indicating the touch area and the touching time, and the step of generating password codes may generate the password codes based on the touch area and the touching time. It is possible to generate password codes including two types of data, the touch area and the touching time. The reliability of the password code can be enhanced.

On the above-mentioned user authentication method, the user authentication method may further include a step of generating data indicating an untouched time, the untouched time being a period from a time when a touched object is removed from the input screen to another time when a removed object starts touching the input screen again, and the step of generating password codes generates the password codes based on touch area, the touching time, and the untouched time. It is possible to generate password codes by adding another type of data, the untouched time. The reliability of the password code can be enhanced.

According to yet another aspect of the present invention, preferably, there is provided a user authentication method comprising the steps of measuring a period from a time when a touched object is removed from the input screen to another time when a removed object starts touching the input screen again, generating password codes based on the untouched time; and judging whether or not a user is an authorized user. It is possible to generate password codes by adding another type of data, the untouched time. The reliability of the password code can be enhanced.

On the above-mentioned user authentication method, the step of generating password codes generates the password codes for every given sampling cycle, and the step of judging judges whether or not a user is an authorized user according to the number of the password codes. The number of password codes is compared with the number of the prepared password codes. If the numbers are greatly different, the user is determined an unauthorized user. It is thus possible to shorten a determination process.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram of an input device in accordance with a first embodiment of the present invention;

FIG. 2 is a flowchart describing processes of a password judgment unit in accordance with the first embodiment of the present invention;

FIG. 3 is a block diagram of an input device in accordance with a second embodiment of the present invention;

FIG. 4 is a block diagram of an input device in accordance with a third embodiment of the present invention;

FIG. 5 is a block diagram of an input device in accordance with a fourth embodiment of the present invention;

FIG. 6 is a flowchart describing processes of a password judgment unit in accordance with the fourth embodiment of the present invention;

FIG. 7 is a block diagram of an input device in accordance with a fifth embodiment of the present invention;

FIG. 8 is a block diagram of an input device in accordance with a sixth embodiment of the present invention;

FIG. 9 is a block diagram of an input device in accordance with a seventh embodiment of the present invention;

FIG. 10 is a flowchart describing processes of a password judgment unit in accordance with the seventh embodiment of the present invention;

FIG. 11 is a block diagram of an input device in accordance with an eighth embodiment of the present invention;

FIG. 12 is a block diagram of an input device in accordance with a ninth embodiment of the present invention;

FIG. 13 shows a path of a finger on the touch panel while moving the finger on the touch panel;

FIG. 14A shows the path in the X direction;

FIG. 14B shows the path in the Y direction;

FIG. 15 shows how a touch area S changes from a touch starting position G1 to a touch finishing position G2;

FIG. 16 is a flowchart describing comparing processes of sample numbers of a password code generated at a given sampling interval;

FIG. 17 is a flowchart describing password judgment process from the time when the finger start touching the touch panel to the time when finger is removed;

FIG. 18 is a flowchart describing the case where a sample number K of a valid password code is greater than a sample number L of a generated password code;

FIGS. 19A through 19C show comparison examples between the valid password codes and the generated password codes;

FIG. 20 is a flowchart describing the case where the sample number K of the valid password code is smaller than the sample number L of the generated password code;

FIG. 21 is a determination flowchart describing the case where the sample number K of the valid password code and the sample number L of the generated password code are equal; and

FIG. 22 is a flowchart describing overall determination of total touch times of the password, namely, N times.

### DESCRIPTION OF THE PREFERRED EMBODIMENTS

A description will now be given, with reference to the accompanying drawings, of embodiments of the present invention.

### First Embodiment

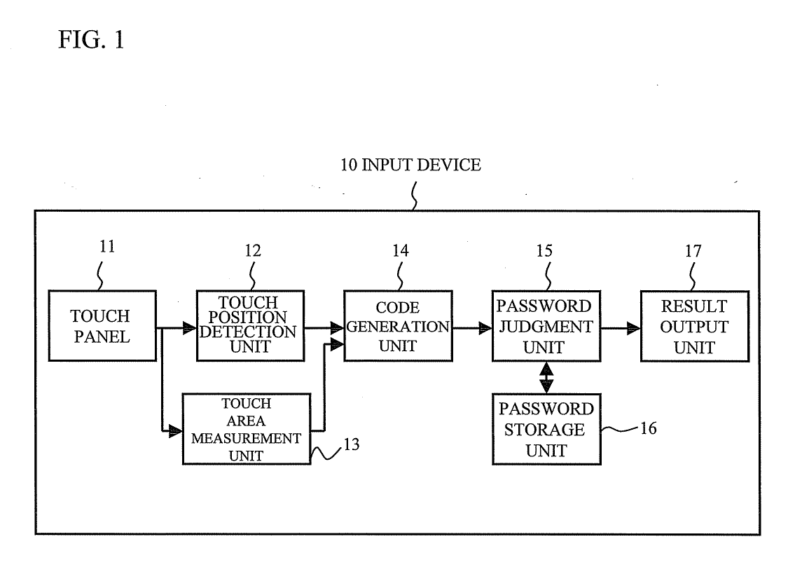

A first embodiment of the present invention will be first described in detail, with reference to the accompanying drawings. FIG. 1 is a block diagram illustrating an input device in accordance with a first embodiment of the present invention. Referring to FIG. 1, an input device 10 includes a touch panel 11, a touch position detection unit 12, a touch area measurement unit 13, a code generation unit 14, a password judgment unit 15, a password storage unit 16, and a result output unit 17. The input device 10 is composed of, for instance, a CPU (Central Processing Unit), a ROM (Read Only Memory), a RAM (Random Access Memory), or the like. The input device 10 carries out the user authentication to check whether the user is a valid one.

The touch panel 11 corresponds to an input screen on which information is input with a finger or pen. The touch position detection unit 12 detects X-Y coordinates (X, Y) of the position on the touch panel 11 touched by the object. Only a position at which the touch starts (a touch starting position) may be detected. The touch area measurement unit 13 measures the maximum touch area on the touch panel 11. Here, the maximum touch area, now labeled Smax, defines a maximum value of the touch area from the time when the finger starts touching the touch panel 11 to the time when the finger is removed from the touch panel 11.

The code generation unit 14 generates a password code based on the touch starting position detected by the touch position detection unit 12 and the maximum value of the touch area Smax measured by the touch area measurement unit 13. For example, in the case where the touch starting position (X, Y) is (Xp1, Yp1) and the maximum area Smax is Sp1, a generated password code is Xp1Yp1Sp1. The code generation unit 14 may generate the password code for every given sampling cycle. In this case, the password judgment unit 15 judges whether the user is an authorized user according to the password code.

The password judgment unit 15 compares a proper password code registered in the password storage unit 16 in advance with the password code generated by the code generation unit 14, and determines whether the user is an authorized user. Here, it is almost impossible to reproduce the position and touch area on the touch panel 11 that are identical to those in a predetermined password, when the user touches the touch panel 11. It is necessary to set a certain degree of allowable range. Accordingly, the password judgment unit 15 judges the user based on an allowable value of X-coordinate Xs, an allowable value of Y-coordinate Ys, and an allowable value of the touch area Ss. The password storage unit 16 stores proper passwords. The result output unit 17 outputs judgment results, based on matched or unmatched judgment results of N times that have been output from the password judgment unit 15. In the case where that all the passwords are matched, the judgment result is output matched. In the case where there is an unmatched judgment result, even just once, the judgment result is output unmatched.

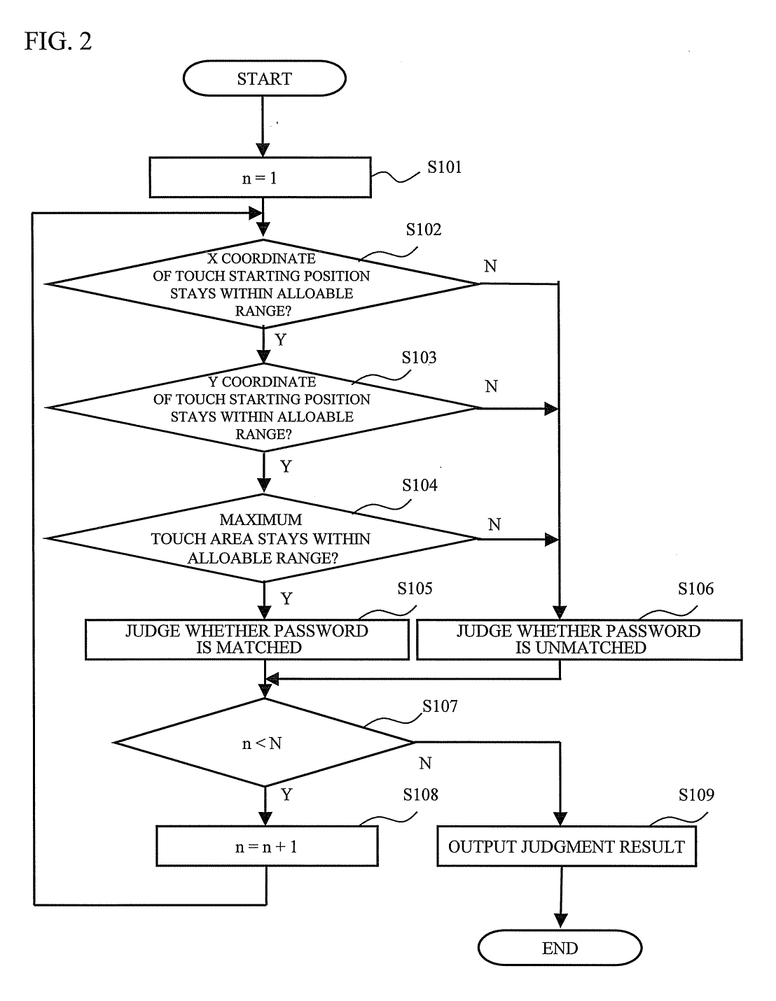

Next, a description will be given of processes of the password judgment unit 15. FIG. 2 is a flowchart describing the processes of the password judgment unit 15 in accordance with the first embodiment of the present invention. Also, a description will be given of the case where the touch panel 11 is touched with a finger several times for the user authentication. Xm1Ym1Sm1 is set to the password code of a first touch and is registered in the password storage unit 16. Correspondingly, Xp1Yp1Sp1 is set to the generated password code generated by the code generation unit 14. In step S101, the password judgment unit 15 starts a first judging process in totally n times.

In step S102, if an X-coordinate of the touch starting position Xp1 stays within the allowable range (Xm1−Xs≦Xp1≦Xm1+Xs), the password judgment unit 15 goes to step S103. If outside the allowable range, the password is judged unmatched in step S106. In step S103, if the Y-coordinate of the touch starting position Yp1 stays within the allowable range (Ym1−Ys≦Yp1≦Ym1+Ys), the password judgment unit 15 goes to step S104. If outside the allowable range, the password is judged unmatched in step S106. In step S104, if the maximum touch area Sp1 stays within the allowable range (Sm1−Ss≦Sp1≦Sm1+Ss), the password judgment unit 15 goes to step S105 and the password is judged matched. If outside the allowable range, the password is judged unmatched in step S106.

In step S107, if a total touch times n does not reach a final touch times N, the password judgment unit 15 increments the total touch times n, goes back to step S102, and repeats the above-mentioned processes. In step S207, if the total touch times n is equal to the final touch times N, the password judgment unit 15 goes to step S109, and the judgment result is output from the result output unit 17.

In accordance with the first embodiment of the present invention, the password code is generated according to the touch position and the touch area. Therefore, the password is not stolen by others. It is thus possible to provide the input device, with which impersonation or spoofing is difficult. In addition, the password need not be input.

### Second Embodiment

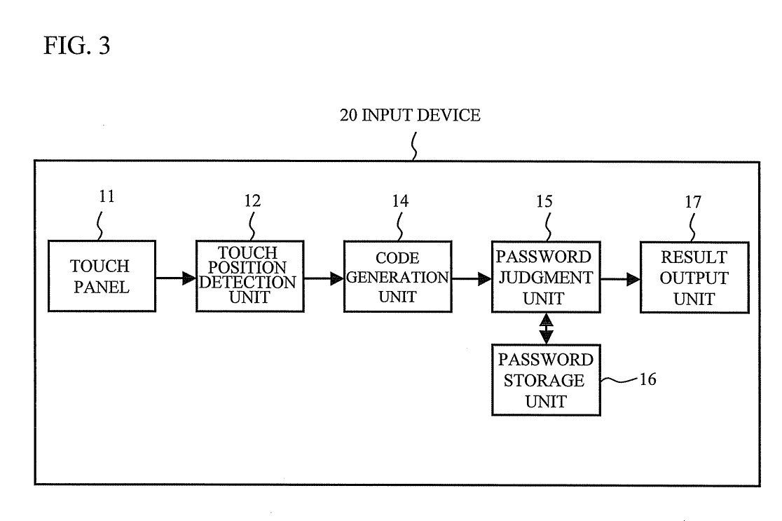

Next, a description will be given of a second embodiment of the present invention. FIG. 3 is a block diagram of an input device 20 in accordance with a second embodiment of the present invention. Referring to FIG. 3, the input device 20 includes the touch panel 11, the touch position detection unit 12, the code generation unit 14, the password judgment unit 15, the password storage unit 16, and the result output unit 17. Hereinafter, in the second embodiment, the same components and configurations as those of the first embodiment have the same reference numerals and a detailed explanation will be omitted, if not otherwise specified.

A description will be given of the operation of the input device in accordance with the second embodiment of the present invention. The code generation unit 14 generates the password code based on the touch starting position detected by the touch position detection unit 12. The password judgment unit 15 compares the password code generated by the code generation unit 14 with the proper password code that has been registered in the password storage unit 16.

In accordance with the second embodiment of the present invention, the password code is generated according to the touch position. Therefore, the password is not stolen by others. It is thus possible to provide the input device, with which impersonation or spoofing is difficult. In addition, the password is not to be input.

### Third Embodiment

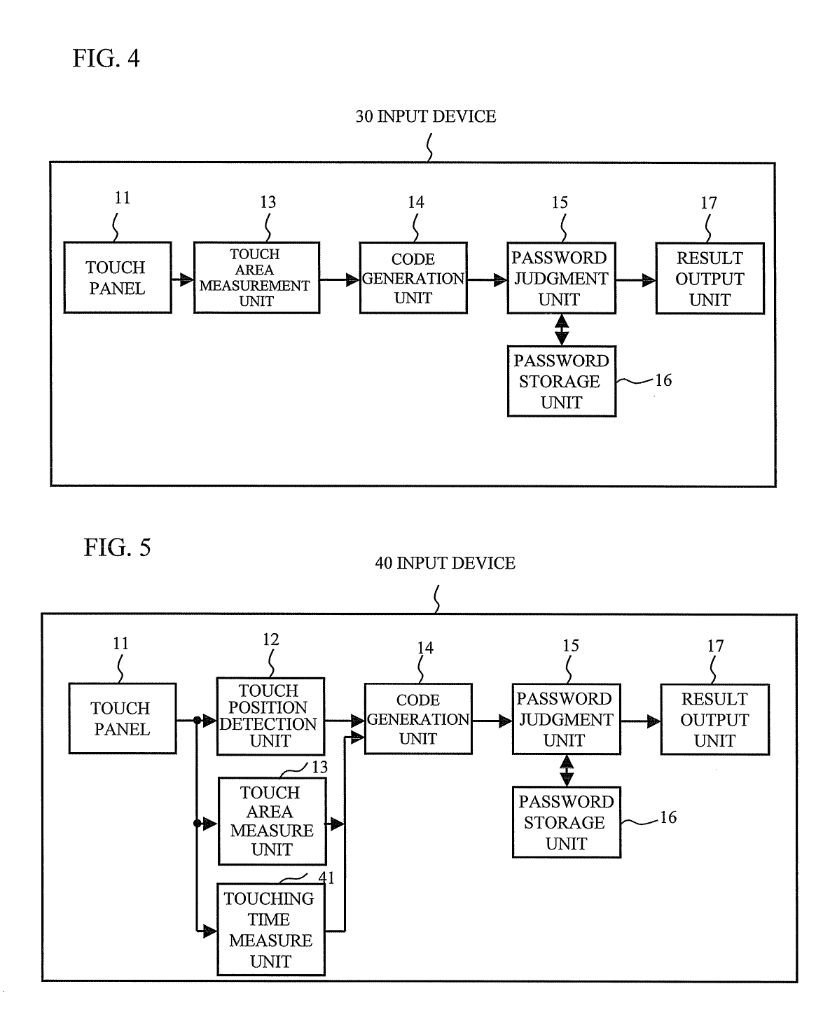

Next, a description will be given of a third embodiment of the present invention. FIG. 4 is a block diagram of an input device in accordance with the third embodiment of the present invention. An input device 30 includes the touch area measurement unit 13, the code generation unit 14, the password judgment unit 15, the password storage unit 16, and the result output unit 17. Hereinafter, in the third embodiment, the same components and configurations as those of the first and second embodiments have the same reference numerals and a detailed explanation will be omitted, if not otherwise specified.

A description will be given of the input device in accordance with the third embodiment of the present invention. The code generation unit 14 generates the password code based on the touch starting position detected by the touch area measurement unit 13. The password judgment unit 15 compares the password code generated by the code generation unit 14 with the proper password code that has been registered in the password storage unit 16.

In accordance with the third embodiment of the present invention, the password code is generated according to the touch area. Therefore, the password is not stolen by others. It is thus possible to provide the input device, with which impersonation or spoofing is difficult. In addition, the password is not to be input.

### Fourth Embodiment

Next, a description will be given of a fourth embodiment of the present invention. FIG. 5 is a block diagram illustrating an input device 40 in accordance with the fourth embodiment of the present invention. An input device 40 includes the touch panel 11, the touch position detection unit 12, the touch area measurement unit 13, a touching time measurement unit 41, the code generation unit 14, the password judgment unit 15, the password storage unit 16, and the result output unit 17. The touching time measurement unit 41 measures a touching time Tpn of the object to the touch panel 11. Hereinafter, in the fourth embodiment, the same components and configurations as those of the first and second embodiments have the same reference numerals and a detailed explanation will be omitted, if not otherwise specified.

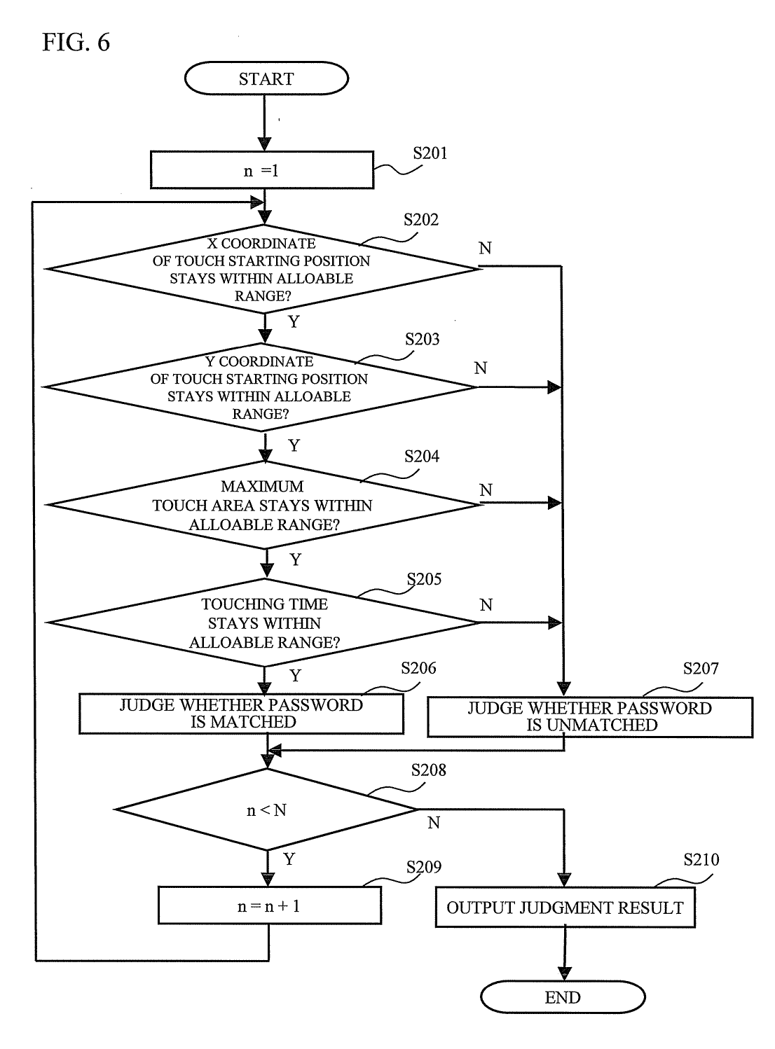

Next, operations of password judgment unit 15 will be described. FIG. 6 is a flowchart describing the processes of the password judgment unit 15 in accordance with the fourth embodiment of the present invention. In the following description, Ts denotes an allowable value of the touching time. The password code of the first touch with a finger that is registered in the password storage unit 16 is set to Xm1Ym1Sm1Tm1. Correspondingly, Xp1Yp1Sp1Tp1 is set to the generated password code generated by the code generation unit 14.

In step S201, the password judgment unit 15 starts the flowchart after setting the total touch times n to 1. In step S202, if the X-coordinate of the touch starting position Xp1 stays within the allowable range (Xm1−Xs≦Xp1≦Xm1+Xs), the password judgment unit 15 goes to step S203. If outside the allowable range, the password is judged unmatched in step S207. In step S203, if the Y-coordinate of the touch starting position Yp1 stays within the allowable range (Ym1−Ys≦Yp1≦Ym1+Ys), the password judgment unit 15 goes to step S204. If outside the allowable range, the password is judged unmatched in step S207.

In step S204, if the maximum touch area Sp1 stays within the allowable range (Sm1−Ss≦Sp1≦Sm1+Ss), the password judgment unit 15 goes to step S205. If outside the allowable range, the password is judged unmatched in step S207. In step S205, if the touching time Tp1 stays within the allowable range (Tm1−Ts≦Tp1≦Tm1+Ts), the password judgment unit 15 goes to step S206. If outside the allowable range, the password is judged unmatched in step S207. In step S208, if the total touch times n is not equal to the final touch times N, the password judgment unit 15 increments the total touch times n, goes back to step S202, and repeats the above-mentioned processes. In step S208, if the total touch times n is equal to the final touch times N, the password judgment unit 15 goes to step S109, and the judgment results are output from the result output unit 17.

In accordance with the fourth embodiment of the present invention, the password code is generated according to the touch area and touching time. It is thus possible to strengthen the authenticity of the password code.

### Fifth Embodiment

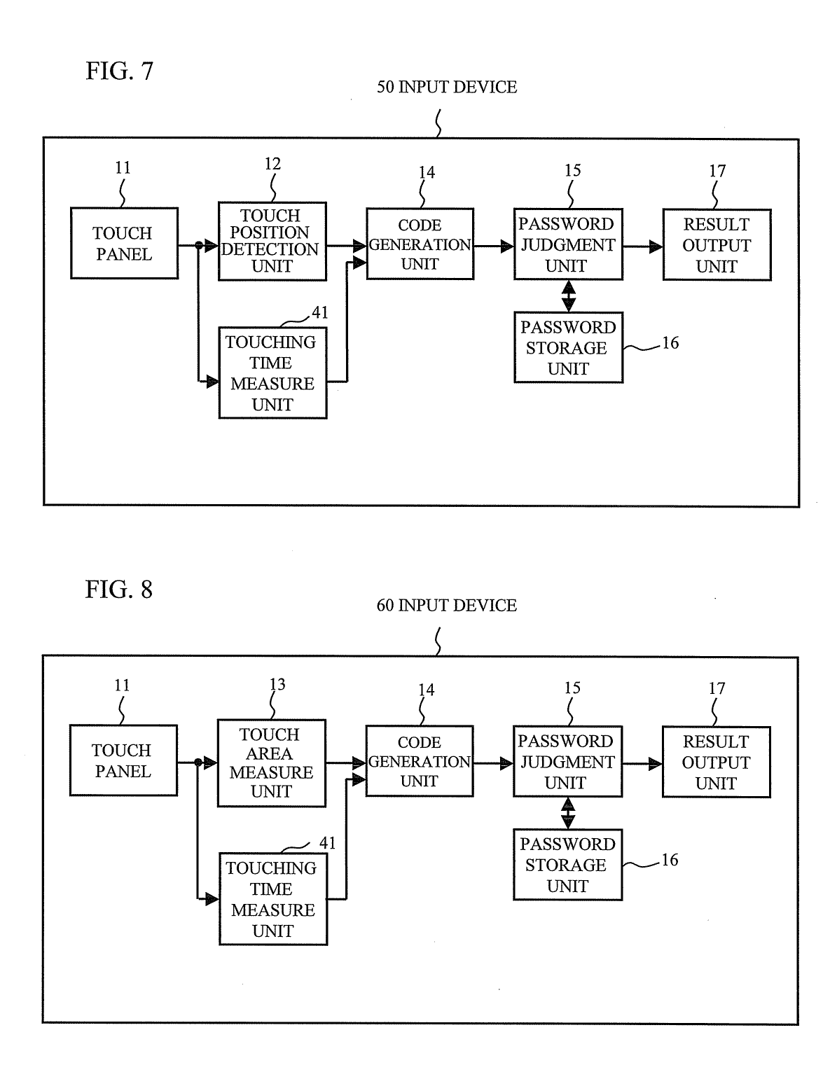

Next, a description will be given of a fifth embodiment of the present invention. FIG. 7 is a block diagram illustrating an input device 50 in accordance with the fifth embodiment of the present invention. An input device 50 includes the touch panel 11, the touch position detection unit 12, the touching time measurement unit 41, the code generation unit 14, the password judgment unit 15, the password storage unit 16, and the result output unit 17. Hereinafter, in the fifth embodiment, the same components and configurations as those of the first through fourth embodiments have the same reference numerals and a detailed explanation will be omitted, if not otherwise specified.

A description will be given of the input device in accordance with the fifth embodiment of the present invention. The code generation unit 14 generates the password code based on the touch starting position and the touching time. The touch starting position is detected by the touch position detection unit 12. The touching time is measured by the touching time measurement unit 41. The password judgment unit 15 compares the password code generated by the code generation unit 14 with the proper password code that has been registered in the password storage unit 16.

In accordance with the fifth embodiment of the present invention, the password code is generated according to the touch area and touching time. It is thus possible to strengthen the authenticity of the password code.

### Sixth Embodiment

Next, a description will be given of a sixth embodiment of the present invention. FIG. 8 is a block diagram illustrating an input device 60 in accordance with the sixth embodiment of the present invention. The input device 60 includes the touch panel 11, the touch area measurement unit 13, the touching time measurement unit 41, the code generation unit 14, the password judgment unit 15, the password storage unit 16, and the result output unit 17. Hereinafter, in the sixth embodiment, the same components and configurations as those of the first through fourth embodiments have the same reference numerals and a detailed explanation will be omitted, if not otherwise specified.

A description will be given of the input device in accordance with the sixth embodiment of the present invention. The code generation unit 14 generates the password code based on the maximum touch area and the touching time. The maximum touch area is measured by the touch area measurement unit 13. The touching time is measured by the touching time measurement unit 41. The password judgment unit 15 compares the password code generated by the code generation unit 14 with the proper password code that has been registered in the password storage unit 16. The result output unit 17 outputs the judgment result output from the password judgment unit 15.

In accordance with the sixth embodiment of the present invention, the password code is generated according to the touch area and touching time. It is thus possible to strengthen the authenticity of the password code.

### Seventh Embodiment

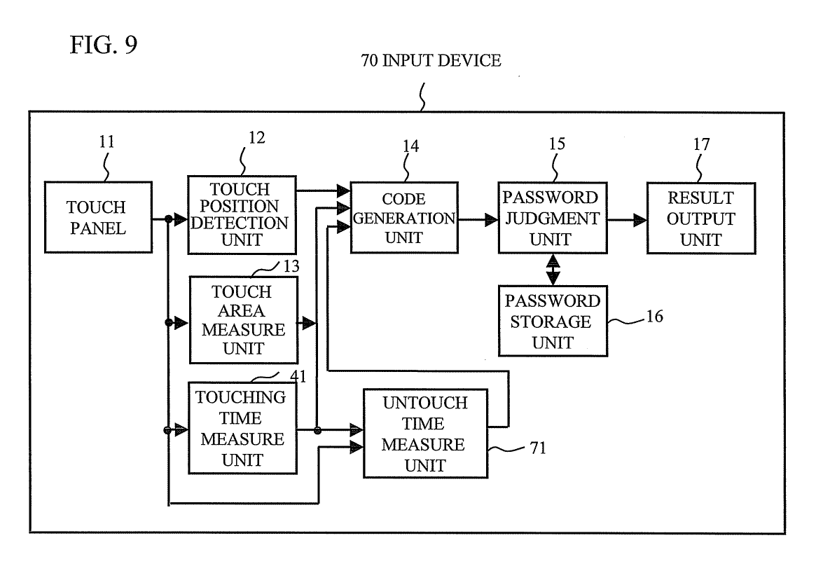

Next, a description will be given of a seventh embodiment of the present invention. FIG. 9 is a block diagram illustrating an input device 70 in accordance with the seventh embodiment of the present invention. The input device 70 includes the touch panel 11, the touch position detection unit 12, the touch area measurement unit 13, the touching time measurement unit 41, an untouched time measurement unit 71, the code generation unit 14, the password judgment unit 15, the password storage unit 16, and the result output unit 17. Hereinafter, in the seventh embodiment, the same components and configurations as those of the first through seventh embodiments have the same reference numerals and a detailed explanation will be omitted, if not otherwise specified. The untouched time measurement unit 71 measures an untouched time Upn, which is a period from the time when the object in contact with the touch panel 11 is removed from the touch panel 11 to the time when the object touches the touch panel 11 again.

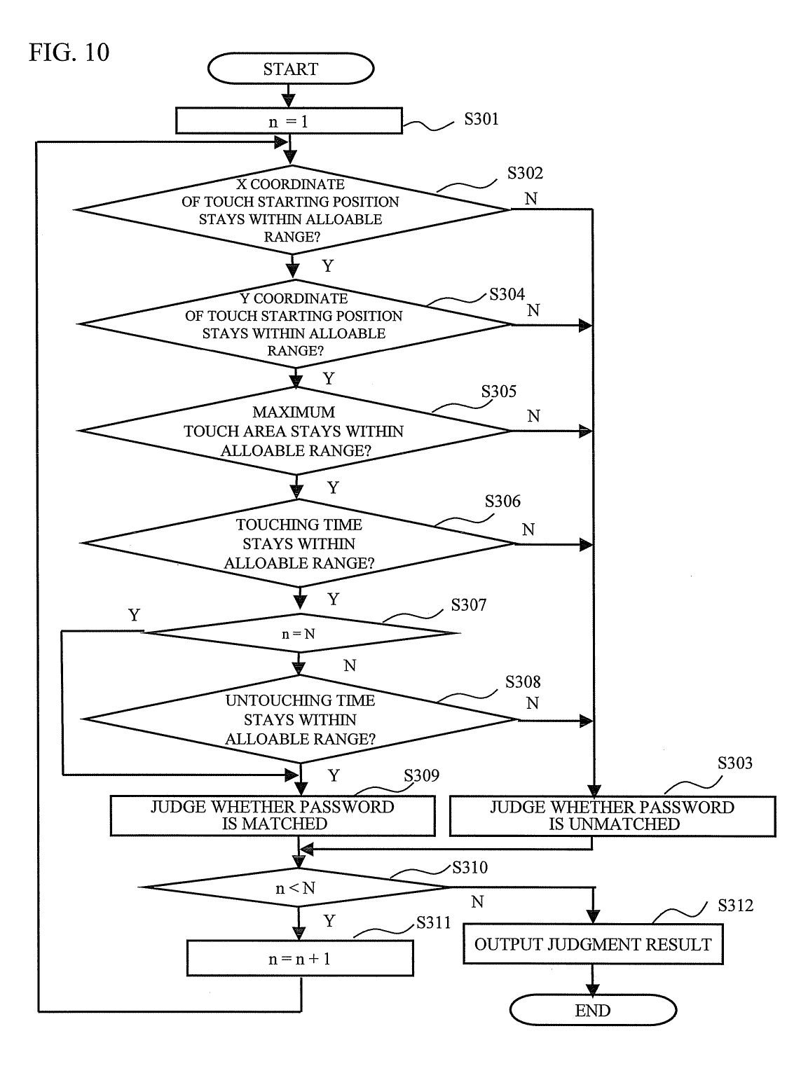

Next, a description will be given of the operations of the password judgment unit 15. FIG. 10 is a flowchart of the password judgment unit 15. In the following description, Us is an allowable value of the untouched time. Xm1Ym1Sm1Tm1Um1 is set to the password code of the first touch and is registered in the password storage unit 16. Correspondingly, Xp1Yp1Sp1Tp1Up1 is set to the generated password code generated by the code generation unit 14.

In step S301, the password judgment unit 15 starts the first judging process after setting the total touch times n to 1. In step S302, if the X-coordinate of the touch starting position Xp1 stays within the allowable range (Xm1−Xs≦Xp1≦Xm1+Xs), the password judgment unit 15 goes to step S304. If outside the allowable range, the password is judged unmatched in step S303. In step S304, if the Y-coordinate of the touch starting position Yp1 stays within the allowable range (Ym1−Ys≦Yp1≦Ym1+Ys), the password judgment unit 15 goes to step S305. If outside the allowable range, the password is judged unmatched in step S303.

In step S305, if the maximum touch area Sp1 stays within the allowable range (Sm1−Ss≦Sp1≦Sm1+Ss), the password judgment unit 15 goes to step S306. If outside the allowable range, the password is judged unmatched in step S303. In step S306, if the touching time Tp1 stays within the allowable range (Tm1−Ts≦Tp1Tm1+Ts), the password judgment unit 15 goes to step S307. If outside the allowable range, the password is judged unmatched in step S303. In step S307, if the total touch times n is not equal to the final touch times N, if the untouched time Up1 stays within the allowable range in step S308 (Um1−Us≦Up1≦Um1+Us), go to step S309 and the password is judged matched. If outside the allowable range, the password is judged unmatched in step S303.

In step S310, if a total touch times n does not reach the final touch times N, the password judgment unit 15 increments the total touch times n, goes back to step S302, and repeats the above-mentioned processes. In step S310, if the total touch times n is equal to the final touch times N, the password judgment unit 15 goes to step S312, and the judgment result is output from the result output unit 17.

In accordance with the seventh embodiment of the present invention, the password code is generated according to the touch area and untouched time. It is thus possible to strengthen the authenticity of the password code.

### Eighth Embodiment

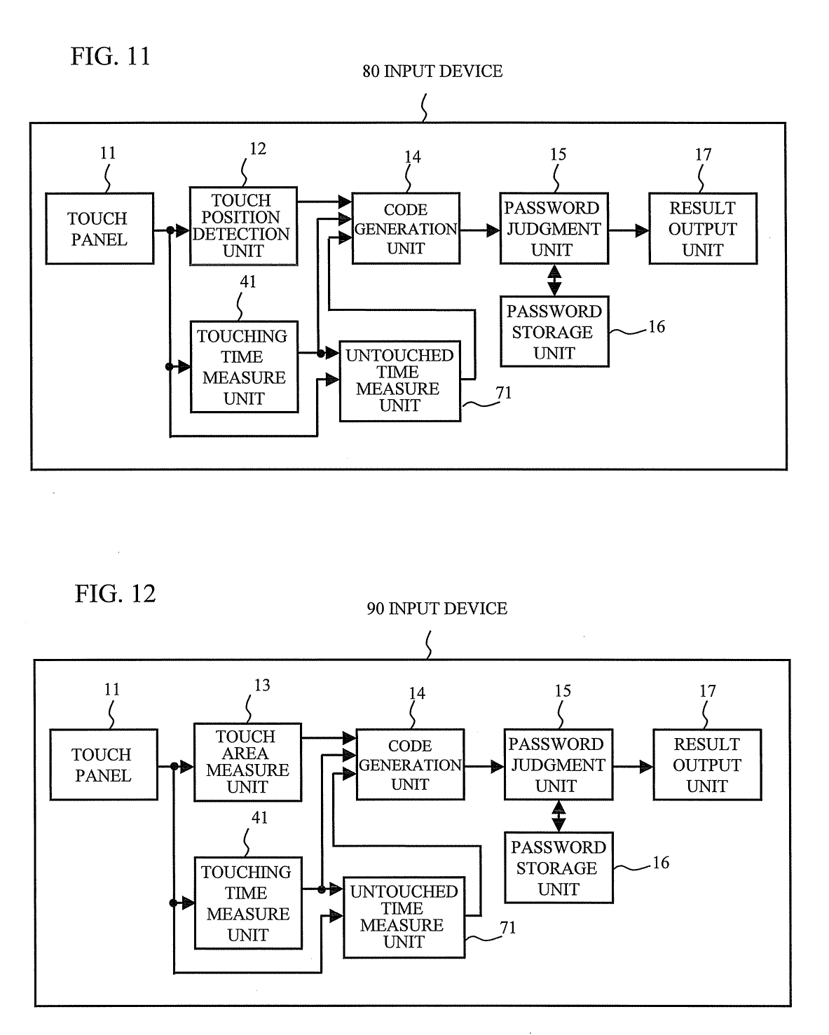

Next, a description will be given of an eighth embodiment of the present invention. FIG. 11 is a block diagram illustrating an input device 80 in accordance with the eighth embodiment of the present invention. The input device 80 includes the touch panel 11, the touch position detection unit 12, the touching time measurement unit 41, the untouched time measurement unit 71, the code generation unit 14, the password judgment unit 15, the password storage unit 16, and the result output unit 17. Hereinafter, in the seventh embodiment, the same components and configurations as those of the first through eighth embodiments have the same reference numerals and a detailed explanation will be omitted, if not otherwise specified.

A description will be given of the input device in accordance with the eighth embodiment of the present invention. The code generation unit 14 generates the password code based on the touch starting position, the touching time, and the untouched time. The touch starting position is detected by the touch position detection unit 12. The touching time is measured by the touching time measurement unit 41. The untouched time is measured by the untouched time measurement unit 71. The password judgment unit 15 determines whether the password code generated by the code generation unit 14 matches with the proper password code that has been registered in the password storage unit 16. The result output unit 17 outputs the judgment result that has been made by the password judgment unit 15.

In accordance with the eighth embodiment of the present invention, the password code is generated according to the touch area, the touching time, and the untouched time. It is thus possible to strengthen the authenticity of the password code.

### Ninth Embodiment

Next, a description will be given of a ninth embodiment of the present invention. FIG. 12 is a block diagram illustrating an input device 90 in accordance with the ninth embodiment of the present invention. The input device 90 includes the touch panel 11, the touch area measurement unit 13, the touching time measurement unit 41, the untouched time measurement unit 71, the code generation unit 14, the password judgment unit 15, the password storage unit 16, and the result output unit 17. Hereinafter, in the ninth embodiment, the same components and configurations as those of the first through eighth embodiments have the same reference numerals and a detailed explanation will be omitted, if not otherwise specified.

A description will be given of the input device in accordance with the eighth embodiment of the present invention. The code generation unit 14 generates the password code based on the touch area, the touching time, and the untouched time. The touch area is measured by the touch area measurement unit 13. The touching time is measured by the touching time measurement unit 41. The untouched time is measured by the untouched time measurement unit 71. The password judgment unit 15 determines whether the password code generated by the code generation unit 14 matches with the proper password code that has been registered in the password storage unit 16. The result output unit 17 outputs the judgment result that has been made by the password judgment unit 15.

In accordance with the ninth embodiment of the present invention, the password code is generated according to the touch area, the touching time, and the untouched time. It is thus possible to strengthen the authenticity of the password code.

### Tenth Embodiment

Next, a description will be given of a tenth embodiment of the present invention. The input device in accordance with the tenth embodiment has the same configurations as in the first embodiment. A description will be given with reference to FIG. 1. The tenth embodiment of the present invention is the case where the touch panel 11 is touched while moving the finger on the touch panel 11.

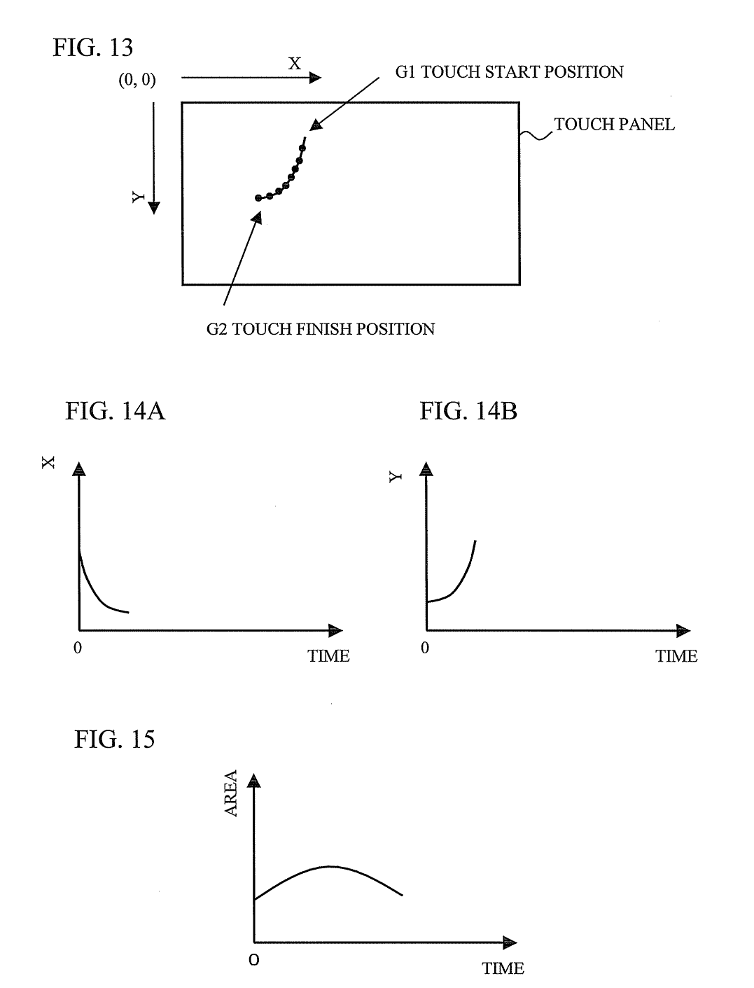

FIG. 13 shows a path of the finger on the touch panel 11 while moving the finger on the touch panel 11. Referring to FIG. 13, the horizontal axis defines the X-coordinate, and the vertical axis defines the Y-coordinate. FIG. 13 shows a path from a touch starting position G1 to a touch finishing position G2. In this case, FIGS. 14A and 14B show the path in X and Y directions from the touch starts to end. FIG. 14A shows the path in the X direction. FIG. 14B shows the path in the Y direction. In FIGS. 14A and 14B, the horizontal axis is set to time t, and the vertical axis is set to the X-coordinate value or Y-coordinate value.

FIG. 15 shows how a touch area S changes from the touch starting position G1 to the touch finishing position G2 shown in FIG. 13. Referring to FIG. 15, the horizontal axis is set to the time t, and the vertical axis is set to an area S. As shown in FIG. 15, the touch area S is small when the touch starts, and the touch area S becomes greater gradually, and then from a certain time, the touch area S becomes smaller as the finger is gradually removed.

The touch position detection unit 12 extracts samples from X and Y directions with a given sampling cycle and outputs to the code generation unit 14. For instance, if there are L samples in a first touching path, the touch position detection unit 12 detects the touch positions such as (Xp11, Yp11), (Xp12, Yp12), . . . , and (Xp1L, Yp1L). The touch area measurement unit 13 measures the area of the first touching path with the same sampling cycle as that of the touch position detection unit 12. If there are L samples, for example, the touch area measurement unit 13 measures the touch areas Sp11, Sp12, . . . , and Sp1L.

The code generation unit 14 generates password codes Xp11Yp11Sp11, Xp12Yp12Sp12, . . . , and Xp1LYp1LSp1L, based on the information output from the touch position detection unit 12 and the touch area measurement unit 13. The password judgment unit 15 compares the valid password code registered in the password storage unit 16 with the generated password code that is generated by the code generation unit 14. However, the respective sample numbers are not always the same. For instance, there is a case where there are too many samples, the touching time with the finger is too long, there are too many registered samples in advance, or there are a few registered samples in advance. Therefore, first of all, the respective sample numbers should be checked to see if the respective sample numbers are not so different.

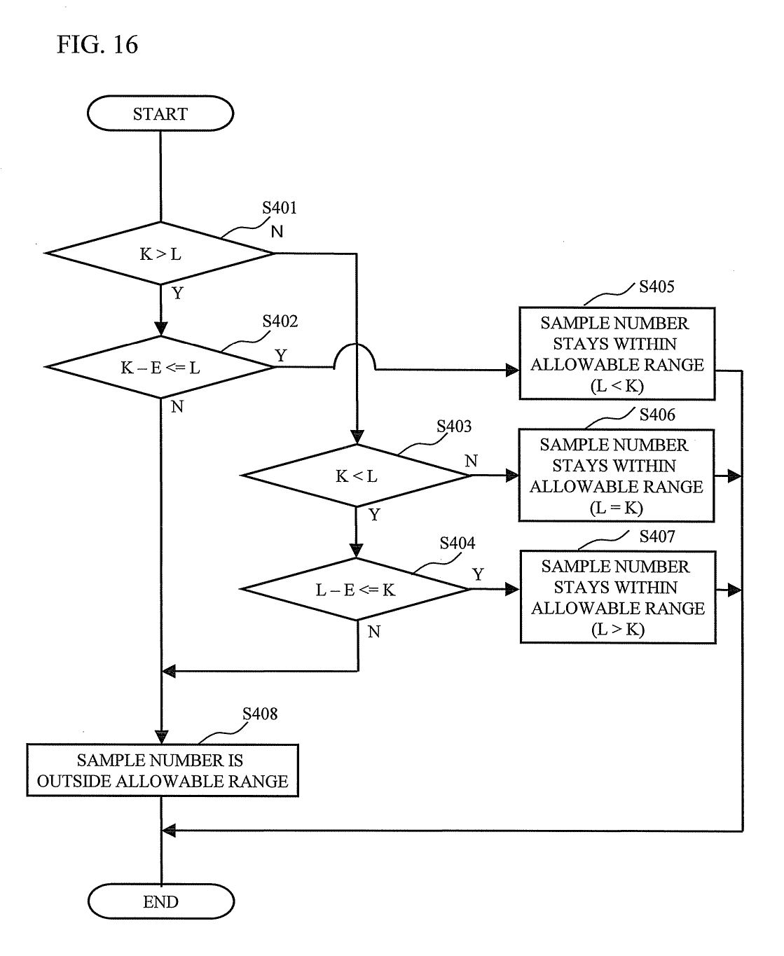

FIG. 16 is a flowchart describing comparison processes of the sample numbers of the password code generated at a given sampling interval. E defines the allowable value of a predetermined sample number. K defines the sample number of the valid password code registered in the password storage unit 16. L defines the sample number of the generated password code generated by the code generation unit 14. In step S401, the password judgment unit 15 compares the sample number K of the valid password codes registered in the password storage unit 16 and the sample number L of the password codes generated by the code generation unit 14.

For example, in the case of the first touch, the valid password codes are Xm11Ym11Sm11, Xm12Ym12Sm12, . . . , and Xm1KYm1KSm1K. The generated password codes are Xp11Yp11Sp11, Xp12Yp12Sp12, . . . , and Xp1LYp1LSp1L. In step S401, if the sample number K of the valid password codes is greater than the sample number L of the generated password codes (K>L), the password judgment unit 15 goes to step S402. If the sample number L of the generated password codes is greater than the sample number K of the valid password codes, go to step S403.

In step S402, if the sample number L of the generated password codes is equal to or greater than a result calculated by subtracting the allowable value E from the sample number K of the valid password code (K−E≦L), the password judgment unit 15 goes to step S405 and determines that the sample number stays within the allowable range. In step S402, if the sample number L of the generated password codes is smaller than the result calculated by subtracting the allowable value E from the sample number K of the valid password codes, the password judgment unit 15 goes to step S408 and determines that the sample numbers are so different that the sample number is outside the allowable range.

In step S403, if the sample number L of the generated password codes is greater than the sample number K of the valid password codes (L>K), and in addition, in step S404, if the sample number K of the valid password code is equal to or greater than a result calculated by subtracting the allowable value E from the sample number L of the generated password codes (L−E≦K), the password judgment unit 15 goes to step S407 and determines that the sample number stays within the allowable range. In step S403, if the sample number L of the generated password codes is equal to the sample number K of the valid password codes (K=L), the sample number stays within the allowable range.

In step S404, if the sample number K of the valid password codes is smaller than the calculation result by subtracting the allowable value E from the sample number L of the generated password codes (L−E>K), the password judgment unit 15 goes to step S408 and determines that the sample numbers are so different that the sample number is outside the allowable range.

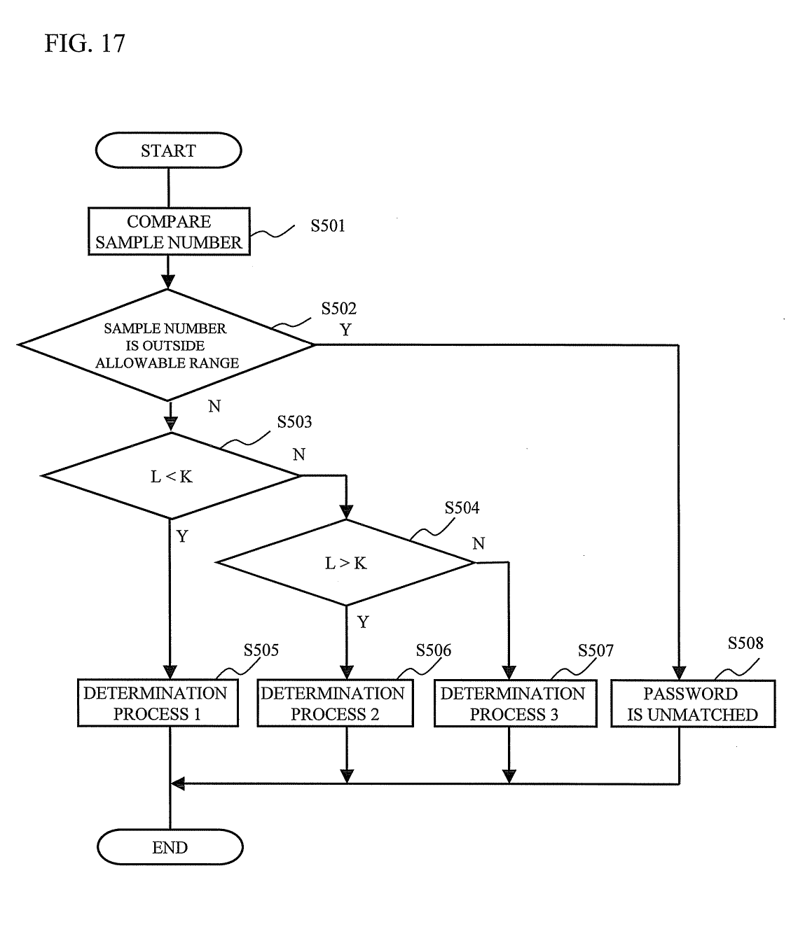

Next, a description will be given of a password judgment process from the time when the finger starts touching the touch panel 11 to the time when finger is removed from the touch panel 11. FIG. 17 is a flowchart describing the password judgment process from the time when the finger start touching the touch panel 11 to the time when finger is removed from the touch panel 11. In step S501, the password judgment unit 15 compares the sample numbers. In step S502, if the sample number is outside the allowable range, the password judgment unit 15 goes to step S508 and determines that the password is unmatched.

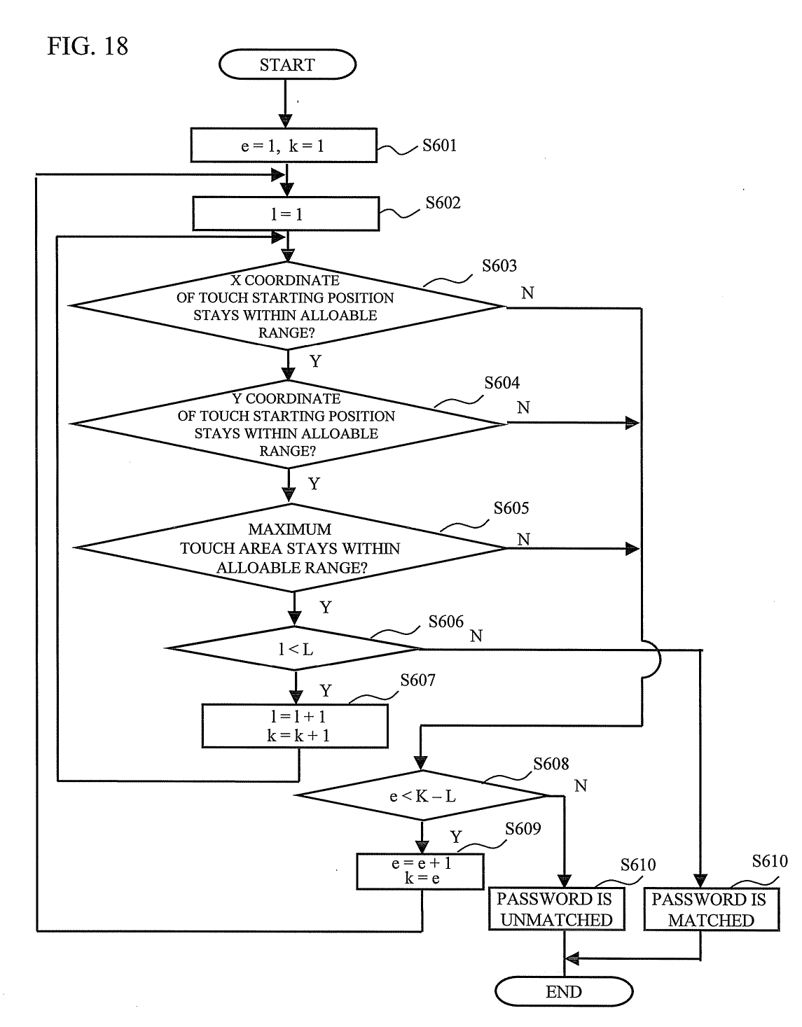

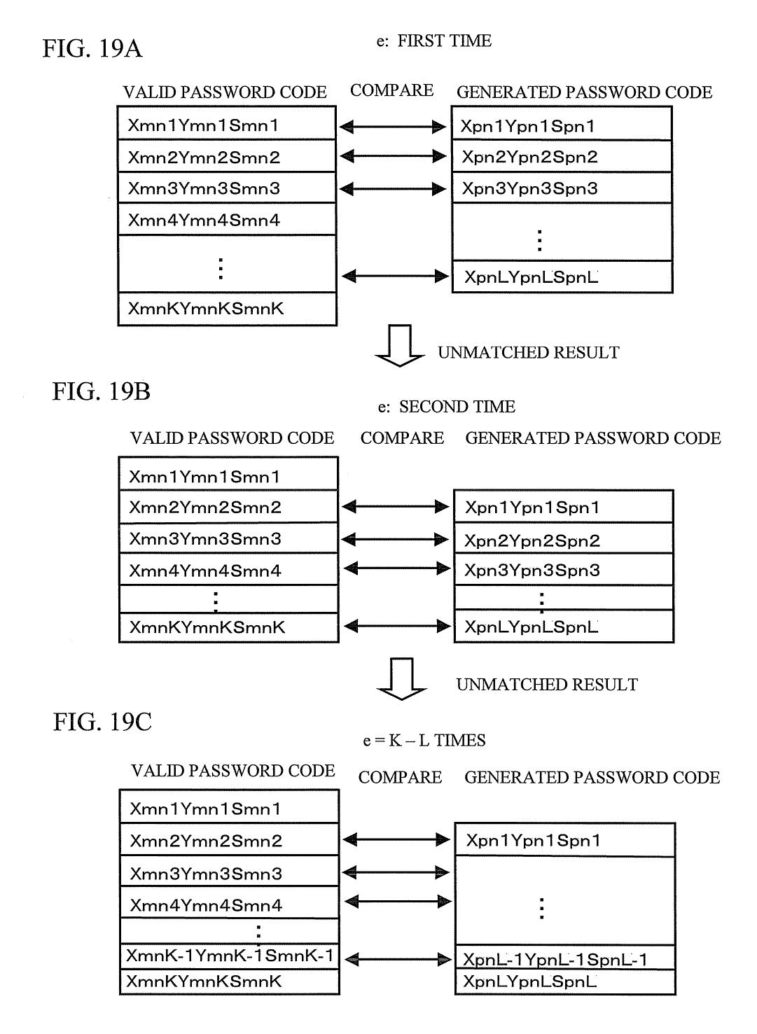

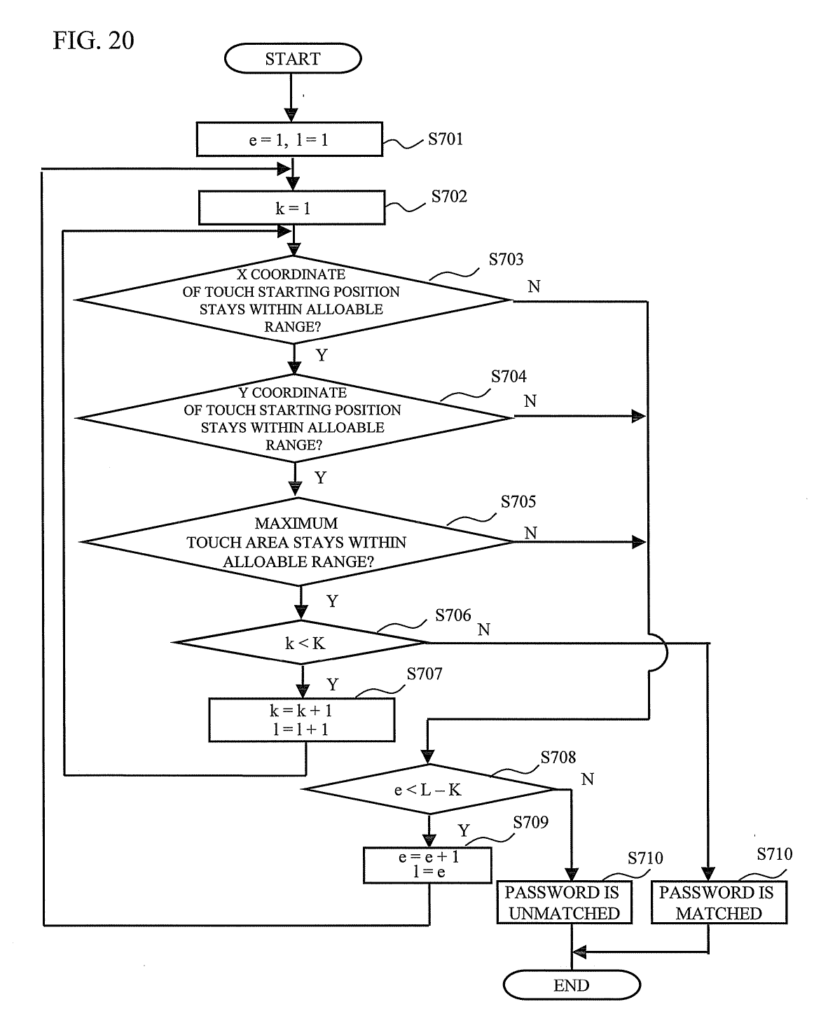

In step S502, the sample number stays within the allowable range, the password judgment unit 15 goes to step S503, and in addition, if the sample number K of the valid password codes is greater than the sample number L of the generated password codes (K>L), go to step S505 to carry out a determination process 1 shown in FIG. 18. If the sample number K of the valid password codes is smaller than the sample number L of the generated password codes (K<L), go to step S506 to carry out a determination process 2 shown in FIG. 19. If the sample number K of the valid password codes is equal to the sample number L of the generated password codes (K=L), go to step S507 to carry out a determination process 3 shown in FIG. 20.

Next, a description will be given of the determination process 1 in the case where the sample number K of the valid password codes is greater than the sample number L of the generated password codes, with reference to FIG. 18. FIG. 18 is a flowchart describing the case where the sample number K of the valid password codes is greater than the sample number L of the generated password codes.

FIGS. 19A through 19C show comparison examples between the valid password codes and the generated password codes. Referring to FIG. 19A, the valid password code and the generated password code are compared on a one-to-one basis for every sampling. After comparing with all the samples of the generated password codes, if the result is determined unmatched, as shown in FIG. 19B, and the valid password coded are shifted by one sample, all the samples of the generated password are compared. Even if the result is determined unmatched again, as shown in FIG. 19C, the valid password coded are shifted by one sample again until K−L times. That is, K−L times denotes the number of the difference between the sample number K of the valid password codes and the sample number L of the generated password codes. A comparison starting position of the valid password code is shifted one by one.

Referring to FIG. 18, in step S601, the password judgment unit 15 sets a counter value e to “1” to carry out a first determination. In step S603, if an X-coordinate Xpn1 of the touch starting position stays within the allowable range (Xmnk−Xs≦Xpnl≦Xmnk+Xs) with a firstly generated password code, the password judgment unit 15 goes to step S604. If not, go to step S608.

In step S604, if a Y-coordinate Ypn1 of the touch starting position stays within the allowable range (Ymnk−Ys≦Ypnl≦Ymnk+Ys), the password judgment unit 15 goes to step S605. If not, go to step S608. In step S605, if a maximum area Spn1 stays within the allowable range (Smnk−Ss≦Spnl≦Smnk+Ss), the password judgment unit 15 goes to step S606. If not, go to step S608.

In step S606, if there is a sample of another generated password code (1<L), the password judgment unit 15 goes to step S607 and increments the sample of the generated password code and the sample of the valid password code respectively one by one, and goes back to step S603. In step S603, the same process is performed on a secondly generated password code. In step S606, if a final generated password code has been determined (1<L is not satisfied), go to step S611 and determines that the password is matched.

In step S608, if the counter value e is smaller than the result calculated by subtracting the sample number L of the generated password codes from the sample number K of the valid password codes (e<K−L), the password judgment unit 15 goes to step S609 to increment the counter value and set the sample of the valid password code k to e, and goes back to step S602 to repeat the above-mentioned processes again. Thus, as shown in FIG. 19B, all the samples of the generated password codes are compared, after shifting the valid password codes by one sample. In step S608, if the counter value e is smaller than the result calculated by subtracting the sample number L of the generated password codes from the sample number K of the valid password codes (e<K−L is not satisfied), go to step S610, determine that the password is unmatched, and complete the process.

Next, a description will be given of the determination process 2 in the case where the sample number K of the valid password codes is smaller than the sample number L of the generated password codes, with reference to FIG. 20. FIG. 20 is a flowchart describing the case where the sample number K of the valid password code is smaller than the sample number L of the generated password code. Referring to FIG. 20, in step S701, the password judgment unit 15 sets a counter value e to “1” to carry out a first determination. In addition, another counter value l is set to “1”, the firstly generated password codes is used in the determination.

The password judgment unit 15 sets k to 1, and uses the first valid password code (in step S702). In step S703, if the X-coordinate of the touch starting position Xpn1 stays within the allowable range (Xmnk−Xs≦Xpnl≦Xmnk+Xs), go to step S704. If not, go to step S708. In step S704, if the Y-coordinate of the touch starting position Ypn1 stays within the allowable range (Ymnk−Ys≦Ypnl≦Ymnk+Ys), go to step S705. If not, go to step S708.

In step S705, if the maximum area Spn1 stays within the allowable range (Smnk−Ss≦Spnl≦Smnk+Ss), the password judgment unit 15 goes to step S706. If not, go to step S708. In step S706, if the valid password code k is equal to or greater than the final sample K, the password judgment unit 15 goes to step S710 and determines that the password is matched. If the valid password code k is smaller than the final sample K (k<K), go to step S707 to increment the valid password code k and the generated password code l respectively, and goes back to S703 to carry out the above-mentioned process on the second generated password code.

In step S708, if the counter value e is smaller than the result calculated by subtracting the sample number K of the valid password code from the sample number L of the generated password code (e<L−K), the password judgment unit 15 goes to step S709 to increment the counter value e and the generated password code l respectively, and goes back to step S702 to repeat the above-mentioned process again. Thus, as shown in FIG. 19B, all the samples of the generated password code are compared after shifting the valid password code by one sample.

In step S708, if the counter value e is equal to or greater than a result calculated by subtracting the sample number K of the valid password codes from the sample number L of the generated password codes (e≦L−K), the password judgment unit 15 goes to step S710, determines that the password is unmatched, and completes the process.

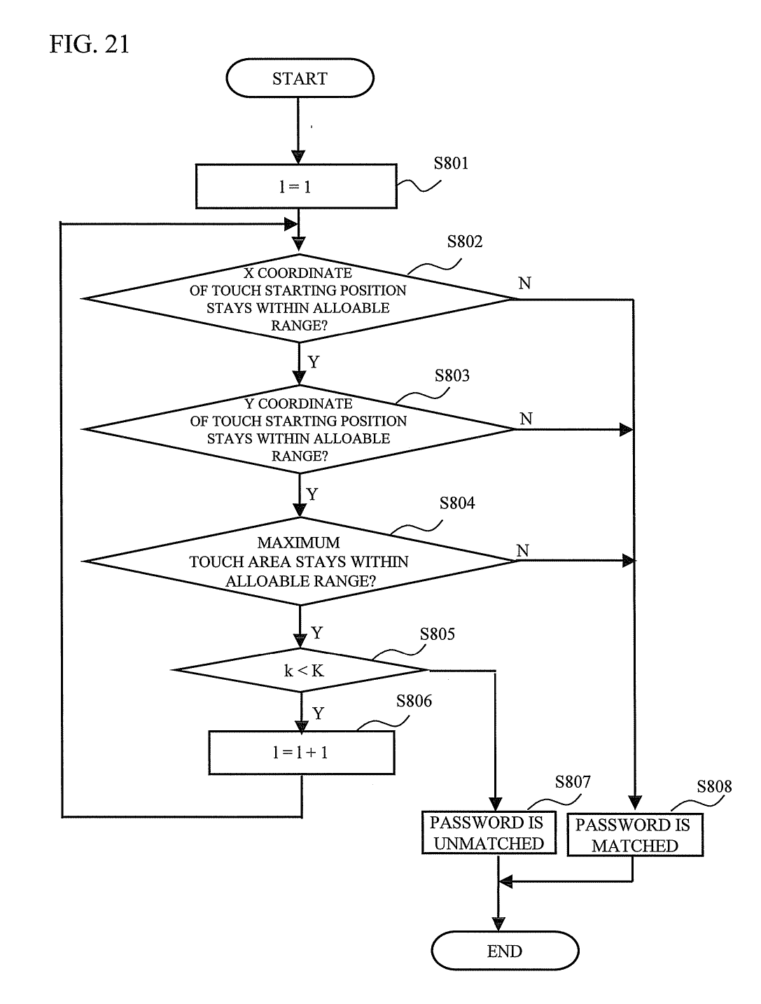

Next, a description will be given of the determination process 3 in the case where the sample number K of the valid password codes and the sample number L of the generated password codes are equal, with reference to FIG. 21. FIG. 21 is a determination flowchart describing the case where the sample number K of the valid password codes and the sample number L of the generated password codes are equal. In step S801, the password judgment unit 15 sets the generated password code to “1” to start the determination process of the first password code.

In step S802, if the X-coordinate Xpn1 of the touch starting position stays within the allowable range (Xmnk−Xs≦Xpnl≦Xmnk+Xs), the password judgment unit 15 goes to step S803. If not, go to step S808. In step S803, if the Y-coordinate Ypn1 of the touch starting position stays within the allowable range (Ymnk−Ys≦Ypnl≦Ymnk+Ys), the password judgment unit 15 goes to step S804. If not, go to step S808.

In step S804, if the maximum area Spnl stays within the allowable range (Smnk−Ss≦Spnl≦Smnk+Ss), the password judgment unit 15 goes to step S805. If not, go to step S808. In step S806, if the compared password code is not the final sample (1<L), go to step S806 to increment the sample of the generated password code, and goes back to step S802 to repeat the above-mentioned process on the next generated password code. In step S806, if the compared password code is the final sample (1=L), go to step S807 to determine that the password is matched and complete the process.

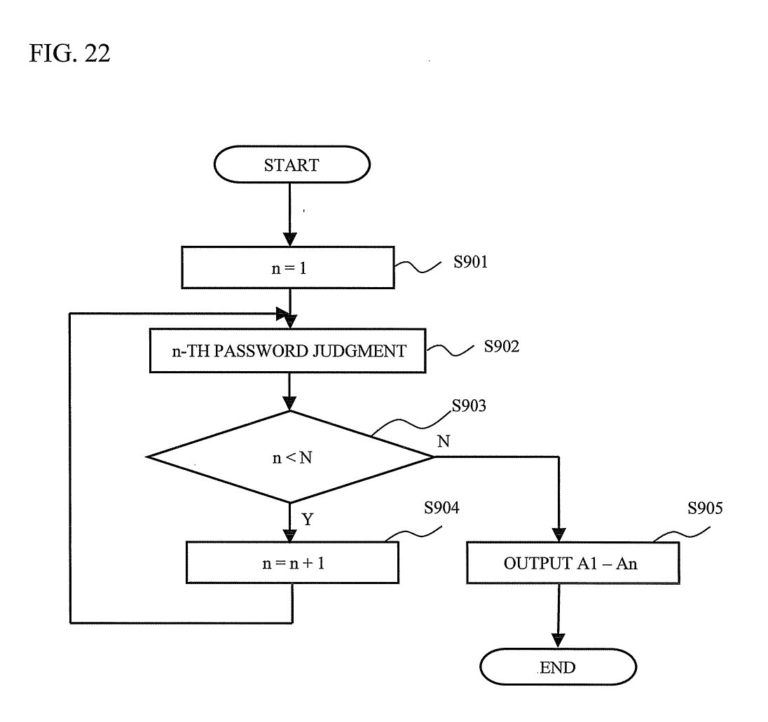

FIG. 22 is a flowchart describing overall determination of the total touch times of the password, namely, N times, in step S900, the password judgment unit 15 starts a first determination of a first touch after setting n to 1. In step S902, the password judgment unit 15 performs an n-th password judgment. In step S903, if the password touch times n is not equal to N (n<N), go to step S904. In step S904, increment the password touch times n and go back to S902. In step S903, if the password touch times n is equal to N (n=N), go to step S905. In step S905, the password judgment unit 15 outputs final judgment results A1−An to the result output unit 17 and completes the process.

In accordance with the tenth embodiment of the present invention, when the generated password code and the valid password code are compared, first of all, the starts of the samples are compared. If the password code is unmatched, the comparison starting position is shifted and repeated by the difference in the number of the samples. It is thus possible to eliminate erroneous judgments.

In accordance with the above-mentioned embodiments of the present invention, the coordinate position when the finger touches on the touch panel, or a combination of the touch areas is input as the password. It is thus possible to perform analogue inputs such as the touch area of the finger, which cannot be performed by digital input such as keyboard input, and thereby possible to provide the input device, with which impersonation or spoofing is difficult and the password need not be input.

The present invention is not limited to the above-mentioned embodiments, and other embodiments, variations and modifications may be made without departing from the scope of the present invention.

The present invention is based on Japanese Patent Application No. 2004-006193 filed on Jan. 14, 2004, the entire disclosure of which is hereby incorporated by reference.

What is claimed is:

1. An input device having an input screen, comprising:
a first unit that extracts L touch positions and L touch areas along a path from a touching start position to a touching finishing position, the touching start position being a position at which an object starts touching the input screen, the touching finishing position being a position at which the object finishes touching the input position, a touch position being a position touched by an object, a touch area being an area touched by the object;
a second unit that generates L password codes respectively indicating the L touch positions and the L touch areas; and
a third unit that judges whether a user is an authorized user based on the L generated password codes and K valid password codes,
wherein:
in the case of L<K, the third unit compares 1st to Lth generated password codes with Ith to (L+I−1)th valid password codes respectively, where I is a positive integer and 1≦I≦(K−L);
the third unit judges the user is the authorized user in a case that all of the 1^{st} to Lth generated password codes stay within allowable ranges of the Ith to (L+I−1)th valid password codes respectively; and
the third unit compares the 1st to Lth generated password codes with the (I+1)th to (L+I)th valid password codes in the case that at least one of the 1st to Lth generated password codes does not stay within an allowable range of a corresponding valid password code among the Ith to (L+I−1)th valid password codes.

2. The input device as claimed in claim 1, wherein the third unit compares the 1st to Lth L generated password codes with the 1st to Lth valid password codes; and
the third unit judges the user is not the authorized user in the case that at least one of the 1st to Lth generated password codes does not stay within an allowable range of a corresponding valid password code among the (K−L)th to Kth valid password codes.

3. The input device as claimed in claim 1, wherein the third unit judges the user is not the authorized user in the case of (K−E)>L, where E is an allowable value.

4. An input device having an input screen, comprising:
a first unit that extracts L touch positions and L touch areas from a touching start position to a touching finishing position, the touching start position being a position at which an object starts touching the input screen, the touching finishing position being a position at which the object finishes touching the input position, a touch position being a position touched by an object, a touch area being an area touched by the object;
a second unit that generates L password codes respectively indicating L touch position and L touch areas; and
a third unit that judges whether a user is an authorized user based on the L generated password codes and K valid password codes
wherein:
in the case of K<L, the third unit compares 1st to Kth valid password codes with Ith to (K+I−1)th generated password codes respectively, where I is a positive integer and 1≦I≦(L−K);
the third unit judges the user is the authorized user in the case that all of the 1st to Kth valid password codes stay within allowable range of corresponding of the Ith to (K+I−1)th generated password codes respectively; and
the third unit compares the 1st to Kth valid password codes with the (I+1)th to (1C+1)th generated password codes in the case that at least one of the 1st to Kth valid password codes does not stay within an allowable range a corresponding generated password code among the Ith to (K+I−1)th generated password codes.

5. The input device as claimed in claim 4, wherein the third unit compares the 1st to Kth valid password codes with the 1st to Kth generated password codes; and
the third unit judges the user is not the authorized user in the case that at least one of the 1st to Kth valid password codes does not stay within an allowable range of a corresponding generated password code among the (L−K)th to Lth generated password codes.

6. The input device as claimed in claim 4, wherein the third unit judges the user is not the authorized user in the case of (L−E)>K, where E is an allowable value.

7. A computer-implemented method of authenticating a user, comprising:
extracting data of a number of touch positions and touch areas identifying a path from a start of a touch of an object onto an input screen to a removal of the object from the input screen;
comparing a number of valid password codes with a number of generated password codes resulting from said extracting until an allowable range of matching occurs; and
authenticating the user when said comparing indicates the allowable range.

8. The computer-implemented method as claimed in claim 7, wherein the authenticating is based on a determination process corresponding to whether the number of valid password codes is less than the number of the generated password codes.

9. The computer-implemented method as claimed in claim 7, wherein the authenticating is based on a first determination process when the number of valid password codes is greater than the number of generated password codes, and
the authenticating is based on a second determination process different from the first determination process when the number of valid password codes is less than the number of generated password codes.

10. The computer-implemented method as claimed in claim 7, wherein when a match within the allowable range does not occur, said comparing is repeated by shifting through the number of the number of valid password codes for comparison by a number difference between the number of the valid password codes and the number of the generated password codes until the allowable range of matching occurs.
